(19) United States
(12) Patent Application Publication
(10) Pub. No.: US 2012/0013640 A1
(43) Pub. Date: Jan. 19, 2012

(54) GRAPHICAL REPRESENTATION OF EVENTS

(75) Inventor: Sheng-Wei Chen, Taipei (TW)

(73) Assignee: Academia Sinica, Taipei (TW)

(21) Appl. No.: 12/837,174

(22) Filed: Jul. 15, 2010

(51) Int. Cl. G09G 5/00

(52) U.S. Cl. 345/619

(57) ABSTRACT

Some general aspects of the invention relate to approaches for generating a graphical representation of scenes related to an event. Information representing an event is first obtained. The information includes, for example, a set of images of physical scenes related to an event, and additional data associated with the images (for example, geo coordinates and audio files). Images are assigned a degree of significance determined from at least the obtained information representing the event. Based on the degree of significance, a set of images is selected for use in the graphical representation, and partitioned into subsets of images each subset to be presented in a respective one of one or more successive presentation units of the graphical representation. In some examples, the graphical representation can be enhanced by introducing textual annotations to the images. A user can then refine the generated graphical representation by modifying the layout and content of the images and annotations

### BACKGROUND

This application relates to systems and methods for generating graphical representation of events.

Digital image capturing devices along with plentiful digital storage space have enabled people to amass large collections of digital media. This media is generally captured with the intention of preserving and sharing the memory of some notable event in the lives of one or more people. Currently, some common ways of sharing media with others are photo browsing, photo slideshows, video slideshows and illustrated text.

### SUMMARY

Some general aspects of the invention relate to a method and apparatus for generating a graphical representation of scenes relating to an event. Information representing an event is first obtained. The information includes, for example, a set of images of physical scenes related to an event, and additional data associated with the images (for example, geographical coordinates and audio files). Data characterizing the images is automatically determined by applying image processing techniques to the visual aspects of the image. Based at least on the data characterizing the images, a set of images is selected to be presented in the graphical representation. The selected images are partitioned into subsets of images, each subset to be presented in a respective one of one or more successive presentation units of the graphical representation. For each subset of images to be presented in a corresponding presentation unit of the graphical representation, visual characteristics are determined based on the degree of significance associated with the images.

One or more of the following features may also be included.

The images of scenes may include images of scenes related to a physical event, a virtual environment, or both.

The data obtained from the machine-readable data storage may include descriptive information of the plurality of images. Determining the data characterizing an image may include determining a degree of significance of the image.

Automatically processing the visual aspects of the image may include identifying one or more individuals in the image, identifying the emotions of one or more individuals, identifying behaviors of one or more individuals, identifying objects in the image, identifying the location in the image or identifying the photographic quality of the image.

Generating a graphical representation of the images related to an event may include accepting user input for modification of one or more presentation units of the graphical representation. Accepting user input for modification of one or more presentation units of the graphical representation may include at least one of modifying the layout of a subset of images, replacing images, adding images; removing images; resizing images; cropping images; reshaping images; adding textual annotations; modifying textual annotations; removing textual annotations; moving textual annotations; resizing textual annotations.

Generating the graphical representation of the images related to an event may include automatically placing textual annotations based on the automatic processing of the visual aspects of the images.

Selecting the set of images to be presented in the graphical representation may include determining the number of images in the selected set based on user input and selecting the determined number of images according to the degree of significance of the images.

Partitioning the selected set of images into subsets of images may include determining a layout of the corresponding subset of images for each subunit of the graphical representation. The layout of the subset of images may include row or column positions of the images.

Determining the visual characteristics may include associating an image with at least one textual description of the scene represented by the image. Determining the visual characteristics may also include associating an image with at least one onomatopoeia based on the scene represented by the image.

The visual characteristics of an image may include the size of the image. The visual characteristics may include the shape of the image.

The graphical representation may take a form substantially similar to a printed comic book. Each presentation unit of the graphical representation may include a page.

In some embodiments, the approaches can be implemented in a system that analyzes the images and metadata related to an event and generates comics of the event in a fully automatic manner. In some embodiments, the system also provides a user-interface that allows users to customize their own comics. As a result, users can easily use the system to share their stories and create individual comics for archival purposes or storytelling.

Embodiments of the invention may have one or more of the following advantages.

The high creative threshold of creating high quality representations of events is overcome in an automated manner. The amount of effort put forth by the creator of the representation of the event can be minimized by employing image processing techniques.

The comic representation of events is more expressive than other methods such as photo browsing or slide shows because they are an advanced collocation of visual material, with text balloons, onomatopoeias, and a volatile two-dimensional layout. The resulting representations are not tied to any particular medium and can exist, for example, in electronic or paper form. The image input is not restricted to any particular form of visual media and can include game screenshots, scanned documents, home videos, demonstrative tutorials, etc. The resulting representations are easy to read in the sense that, for example, readers can choose their own pace or focus only on particular parts of the representation.

Further aspects, features, and advantages of the invention are apparent from the following description, and from the claims.

### DESCRIPTION OF DRAWINGS

FIG. 1 is a block diagram of one embodiment of a comic generation engine.

FIG. 2 illustrates a layout computation method.

FIG. 3 illustrates an image rendering method.

FIG. 4 illustrates an image scoring interface.

FIG. 5 illustrates a comic editing interface.

FIG. 6 illustrates a sample auto-generated comic.

### DETAILED DESCRIPTION

### 1 Comic Generation System

With the rise in popularity and accessibility of digital image capturing devices, more and more people are documenting their lives through photographs and videos. Given the large amount of digital storage now available, many people are amassing large collections of digital media. People commonly want to use their digital media to share their experiences with others. For instance, a person may want to show the interesting architecture and dining experiences that they encountered while on a vacation. However, when it comes time to share experiences with others, the sheer amount of media can be overwhelming. Traditional forms of experience-sharing such as photo browsing, photo slideshows, video slideshows, and illustrated text can be deficient in many ways. Some deficiencies of the traditional forms are that they can be difficult to create, are not very expressive, require too much of readers, are not ubiquitous, and don't offer much control to readers.

The following description provides discussion of approaches for generating graphical representations of events (e.g., vacations, social gatherings, sports events, etc.), for example, in a form similar to a comic book. Using some of the approaches, narrative comics are generated in a semi automatic manner. Also, interactive editing functions are provided for users to generate personalized comics based on their preferences and interests.

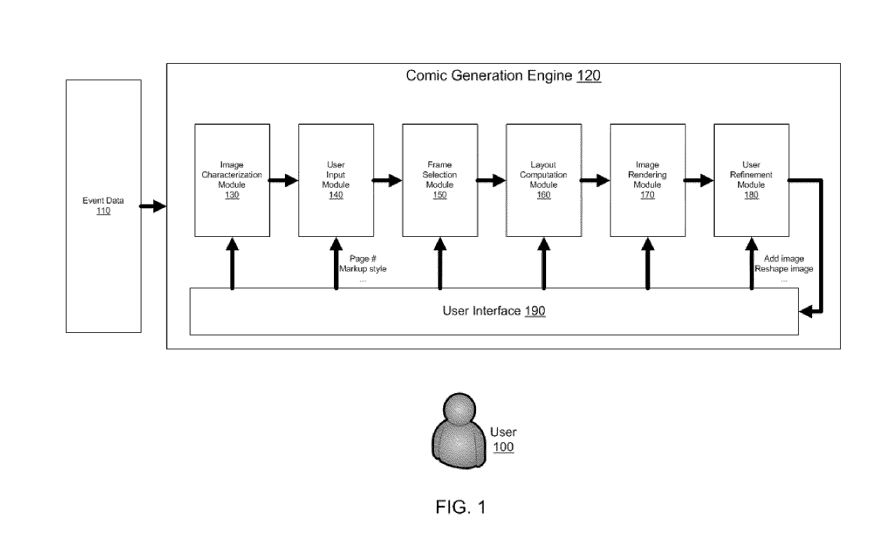

Referring to FIG. 1, one embodiment of a comic generation engine 120 is configured to create graphical representations of an event for storytelling. Very generally, the comic generation engine 120 obtains data including images of physical scenes characterizing an event, and then realigns selected images into comic strips to provide viewers narration of the event in a condensed and pleasing format.

In this embodiment, the comic generation engine 120 includes an image characterization module 130, a user input module 140, a frame selection module 150, a layout computation module 160, an image rendering module 170, and a user refinement module 180. These modules, as described in detail below, make use of data representative of a physical event 110 to create comics in a desired presentation to be shared by various viewers. The comic generation engine 120 also includes a user interface 190 that accepts input from a user 100 to modify parameters used in the comic generation process to reflect user preferences. In this embodiment, user input module 140 and user refinement module 180 make use of data supplied by user interface 190.

### 1.1 Image Characterization

In some embodiments, the image characterization module 130 is configured to accept event data 110. Event data 100 is comprised of a set of images of the event and may include additional information (e.g., audio files associated with images and metadata, such as geographic location, time of day, or user annotation information).

The provided event data is then characterized by image characterization module 130. Image characterization provides clues to the context and semantic details captured in the images. In some examples, the characterization of images of the event is accomplished by applying image processing techniques to each image. The resulting image characterizations may provide clues to the time and place a photo was taken and to the objects, humans, or humans' emotions and behavior in the photo. Some examples of the image processing techniques applied are human recognition, emotion recognition, behavior recognition, object recognition, location identification, and photo quality estimation. Additionally, audio processing and natural language processing may be used to process audio files associated with images.

Humans are involved in almost all stories. Human recognition can be used to identify who is present in an image. One example of human recognition would be to use facial recognition algorithms to identify the face of a particular human.

Emotion recognition can be used to detect the emotions of subjects in an image by detecting facial expressions, gestures, and postures. For example, trip photos with smiling faces are normally more worth remembering.

Behavior recognition can be used to identify how people are behaving or interacting in images. For example, interactions like fighting, shouting, giving the victory sign, and shaking hands all provide valuable information about the context of an image.

Object recognition can be used to identify the context of images. For example, recognizing a birthday cake and colored balloons may imply a birthday party.

Location information can also be extracted from the images of an event. For example, an image containing pots, pans, stoves, and microwaves was likely taken in a kitchen. Another example would be the presence of the Statue of Liberty in a photo indicating that the photo was taken in New York City.

Photo quality information such as exposure, focus, and layout can also be extracted from the images of an event. This information can be used, for example, to differentiate images of similar scenes. Comparing the photo quality information may result in one photo being better suited for use.

Additional information can also be provided with the images of the event. For example, audio files may be associated with images. The audio data contained in the audio file may be processed to automatically create textual annotations of the associated image. Another example of additional data is geographic location information, for example, added using GPS data from a camera. This information could be used by the image characterization module 130 to accurately identify where on earth a particular image was created. Another example of additional data is temporal information, for example the date and time that the image was captured. This information could be used by the frame selection module 150 and the layout computation module 160 to control the pace of the story being told. For example, a small subset of images from an event may have great importance to the event. Temporal information can be used to ensure that the generated comic devotes more frames to the important event.

In some embodiments, the image understanding module 130 may assign a degree of significance to each processed image. The degree of significance depends on the characterization of the particular image and how that characterization fits within the overall story told by the set of images provided by event data 110. In some examples, the degree of significance may be based on scalar significance. For example, the degree of significance could be determined by a set of rules such as: does the image contain humans, does the image contain more than one human, does a human appear in successive shots, is the location new and is the exposure reasonable?

### 1.2 User Input

Some embodiments include a user input module 140 that allows the user 100 to configure basic parameters such as the number of pages desired, the markup style, the textual annotations such as onomatopoeias and text balloons, and the degree of significance of images.

The number of pages desired, N_{page}, determines how many pages will be generated by the comic generation engine 120.

The markup style indicates how textual annotations should be displayed.

The existing textual annotations associated with the images may be edited or new annotations may be added.

The degree of significance, determined in the image characterization module 130, can be displayed to the user 100 at this stage. The user 100 can alter the degree of significance of an image if desired.

1.3 Frame Selection

To produce a concise summary of an event, the frame selection module 150 determines the images of physical scenes to be used for comic generation, for instance, according to an importance or significance determined by the image characterization module 130. In some examples, the total number of pages N_{page} of the comics can be specified by the user 100 in the user input module 140. In one embodiment, when the user 100 initiates the comic generation process, the frame selection module 150 makes two decisions as follows. First, it estimates the total number N_{image} of images needed for the desired comics. Second, it ranks the images of physical scenes in descending order by their degree of significance and selects the top ranked N_{image} number of images to be used in the comics.

More specifically, one approach to estimate the number of images needed for the user-defined N_{page} pages introduces a randomly generated variable N_{IPP} (defining the number of images per page) into the estimation process. For example, given the number of pages N_{page}, the total number of images N_{image} to appear in the comics can be calculated by N_{image}=N_{page}·N_{Ipp}. In some examples, N_{IPP} is selected to follow a normal distribution with a mean equal to 5 and a standard deviation equal to 1 in order to improve the appearance of the comic layout. The user 100 can change the number of images in a comic by simply clicking a “Random” button through the user interface 190 to reset the value of N_{IPP} at any time.

### 1.4 Layout Computation

Once the most significant images are selected, the layout computation module 160 determines how to place these images onto the N_{page} as follows. First, images are partitioned into groups, with each group being placed on the same page. Second, graphical attributes (e.g., shape, size) of the various images on the same page are determined based on their degree of significance and in accordance with the content and layout of the various images. For example, a picture of a car is more suitable to be placed in a lateral frame, while a picture of a high-rise office building is more appropriate to be placed in a vertical frame.

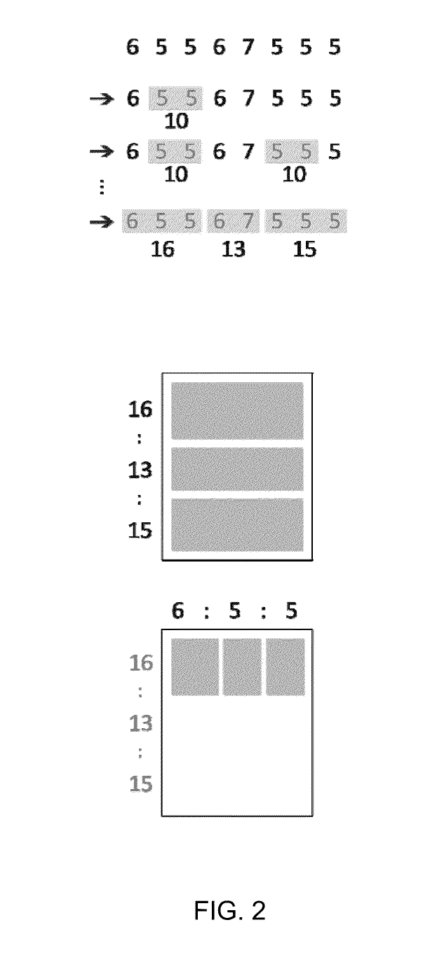

Referring to FIG. 2, one process to partition the images into groups is shown. In the embodiment of FIG. 2, the degree of significance is a scalar significance score. Here, the number of groups is selected to be equal to the number of pages specified by the user 100. Initially, the selected images are divided into page groups based on their significance scores in a chronological order. In this example, 8 images whose significance scores are respectively 6, 5, 5, 6, 7, 5, 5, 5 are selected to be on the same page. These images are then arranged into several rows based on the scores. Once a page has been generated, the image set of the page, the positions, and the sizes of the images on the page are fixed.

Since the presentation of each comic page is laid out in a 2D space, images that have been grouped on one page are placed into blocks in either column or row order. In this particular example, images are placed in rows according to their chronological order and the number of images in a row depends on the significance scores. In one example, neighboring images having the lowest sum of scores are grouped into a row.

In some examples, a region is defined as referring to an image's shape and size on a page. To create variety and visual richness, regions can be randomly reshaped with slants on their edges so that the images look appealing on the comic pages. After the placements of the selected images are determined, the dimensions and regions of the images are calculated based on their significance scores. For instance, images with higher significance scores are assigned with larger areas on a page; conversely, less significant images cover smaller areas.

### 1.5 Image Rendering

In some embodiments, to create the appearance and feeling of a comic book, the image rendering module 170 uses a three-layer scheme to render an image on a page. The three layers include the image, the mask of the image, and text balloons and onomatopoeias (if any).

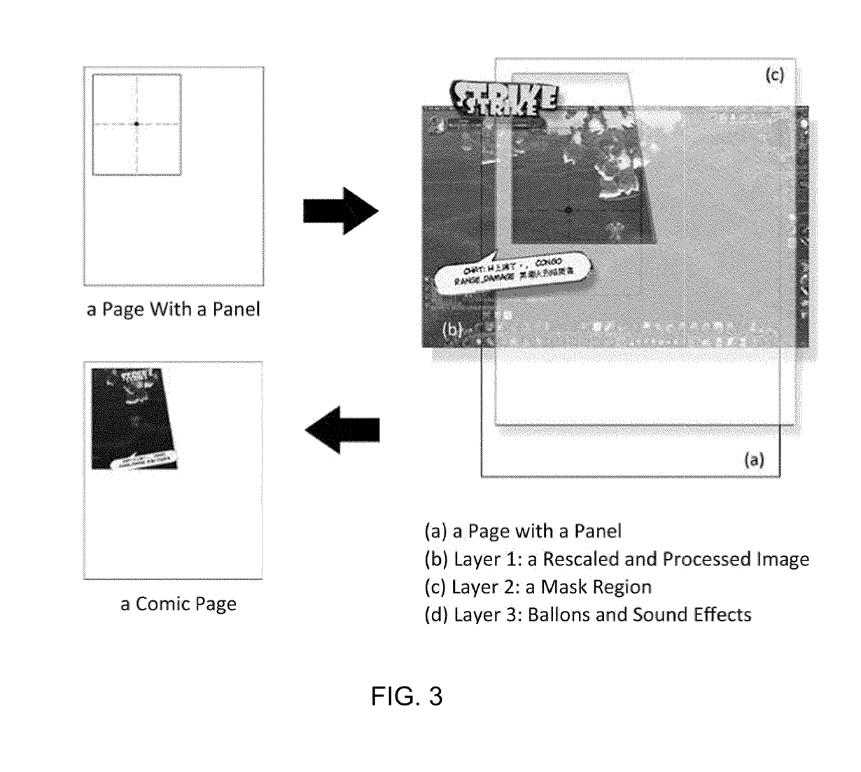

FIG. 3 shows one example of the three-layer scheme. Here, an image is processed as the bottom layer and placed on a panel, which is the area where the image is to be placed on the comic page. The image is then resized to fit the region and drawn with its center aligned on the panel. Next, a mask layer is placed over the bottom layer to crop an image's region; that is, any drawing outside the region is ignored. Finally, embellishments such as text balloons and onomatopoeias are placed on the top layer to enrich expressions in the comic's text. In particular, using image processing techniques, for example saliency maps, the image rendering module can select to put the textual annotations at locations where informative areas such as human faces are not covered.

Once image rendering is completed, the comic generation engine 120 forms a data representation of a comic book having a set of one or more pages, with each page including selected images representing the event. The comic generation engine 120 may store the data representation in electronic forms, for example, as a multimedia file such as JPEG, PNG, GIF, FLASH, MPEG, PDF files, which can be viewed and shared later.

### 1.6 User Refinement

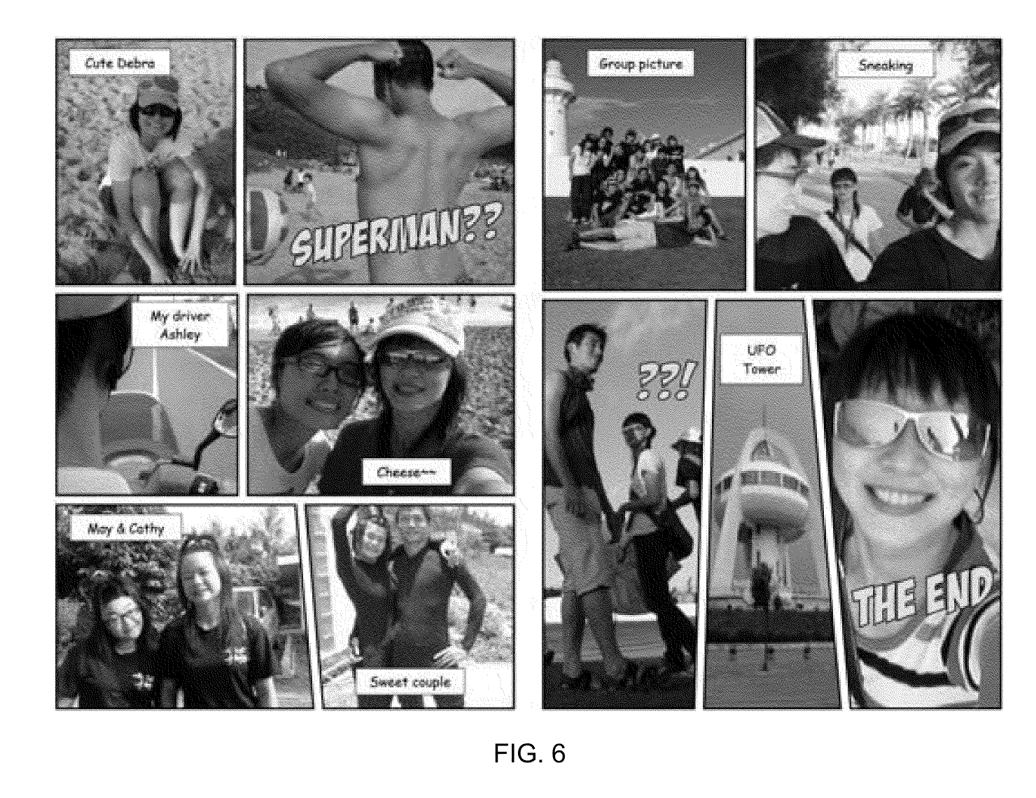

One embodiment includes a user refinement module 180 that allows the user 100 to further refine the comic generated by modules 130-170. The user refinement module 180 allows the user 100 to modify the visual aspects of the comic by utilizing an editing interface. One embodiment of the editing interface is shown in FIG. 6.

The user refinement module 180 enables the user 100 to view the generated comic one page at a time. The user 100 can edit the individual comic pages by altering borders, adding or editing textual annotations such as onomatopoeias and text balloons, and resizing, cropping, adding, replacing, or removing images.

### 2 Examples

For purposes of illustration, the above-described comic generation techniques are applied to create comics for a typical set of images representing a physical event. One example of such a set of images would be photographs from a vacation. These photographs likely include shots of people and interesting sights such as architecture.

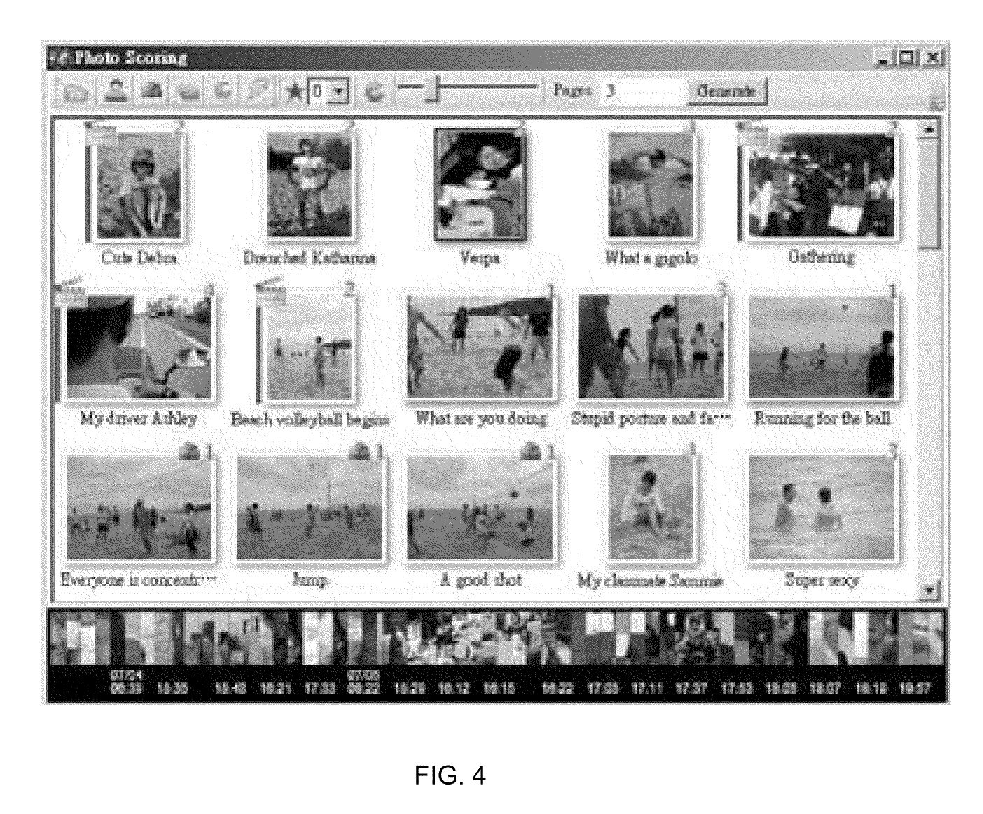

FIG. 4 shows an exemplary user interface by which a user 100 can create comics of their event. Here, the user's event is represented by a set of images (e.g., stored in a computer directory or fetched from an online album). The user 100 can load the set of images by clicking the “Browser” button in the interface.

Upon loading the images, photo scoring takes place. A photo may receive a higher score if it contains humans, contains more than one person, was part of successive shots, was firstly taken at a new place, and was reasonably exposed. The characteristics used in scoring the images are determined by using image processing techniques. For example, the detection of humans and human faces is done using OpenCV and its modules. Location changes and exposure quality are detected based on time and exposure information in EXIF records.

Once the images are loaded and scored, thumbnail images of all (or user-selected) images are provided in a viewing panel in FIG. 4. The significance score of each image is also shown at the top right corner of the image. The user 100 can select thumbnails of images and edit their descriptions and significance scores from the viewing panel.

When the user 100 is satisfied with the descriptions and significance scores of the images, they enter the total number of pages to appear in the comic and hit the “Generate” button. The comic generation engine 120 then determines the most significant images to include in the comic, the layout of these images, and visual characteristics of these images. If desired, the user 100 can change parameters and reiterate the comic generation process.

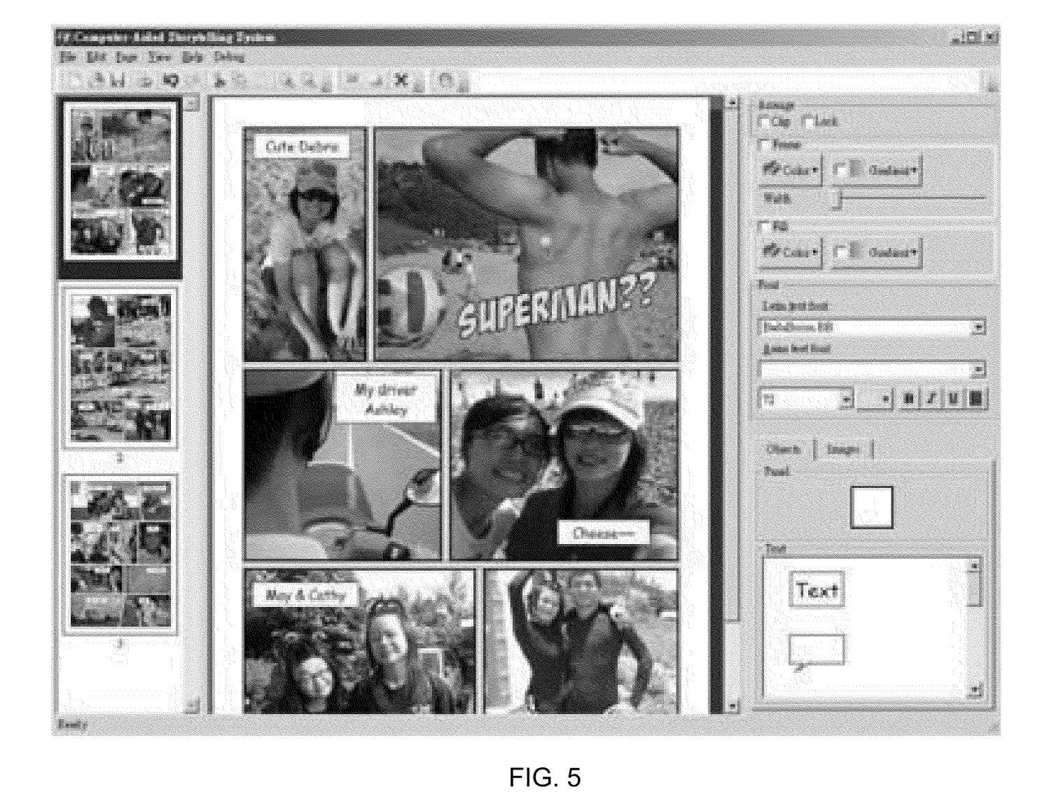

Next, the user 100 has the opportunity to refine the generated comic. FIG. 5 shows an exemplary comic editing interface by which the user 100 can view and edit comic pages. Here, the generated comic can be viewed a page at a time in a viewing window. The user 100 can edit the comic pages by altering borders, adding or editing annotations such as onomatopoeias and text balloons, and resizing, adding, replacing, or removing images.

FIG. 6 shows one example of a comic generated by the comic generation engine 120 of FIG. 1. FIG. 6 is a two page comic, the first page having 6 images in 3 rows and the second page having 5 images in 3 rows. The images are displayed in such a way to provide a summary of the event represented by the provided images. This example also illustrates the diversity of region sizes and visual richness, such as the slants on edges of the regions. The comic generation engine 120 also utilized textual descriptions of images to create textual annotations.

The types of scenes provided to the comic generation engine 120 are not limited to physical scenes. Other embodiments may utilize any number of types of scenes including, for example, virtual scenes and images of artwork.

Various computational and graphical design techniques can be used in the comic generation process to enhance the appearance of the comics. For example, detection techniques such as saliency maps can be used to identify important areas such as human faces and avoid putting text balloons over those areas. Also, image filtering can be applied to images to produce interesting effects. Further, the user interface can be refined by introducing additional editing features to meet user needs, thereby creating a more user-friendly platform for experience sharing and storytelling.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

1. A computer-implemented method comprising:
obtaining, from a machine-readable data storage, data including a plurality of images of scenes related to an event; and
generating a graphical representation of the images of scenes related to an event based on the obtained data, including:
for each one of the plurality of images, automatically determining data characterizing the image by processing the image, at least part of the processing including automatically processing visual aspects of the image;
selecting, from the plurality of images, a set of images to be presented in the graphical representation based at least on the data characterizing the images;
partitioning the selected set of images into subsets of images each subset to be presented in a respective one of one or more successive presentation units of the graphical representation; and
for each subset of images to be presented in a corresponding presentation unit of the graphical representation, determining visual characteristics based at least on the determined degree of significance associated with the images.

2. The computer-implemented method of claim 1, wherein the images of scenes includes images of scenes related to a physical event.

3. The computer-implemented method of claim 1, wherein the data obtained from the machine-readable data storage includes descriptive information of the plurality of images.

4. The computer-implemented method of claim 3, wherein determining the data characterizing an image includes utilizing descriptive information of the image including at least one of: date information, time information, location information, audio annotation, textual annotation.

5. The computer-implemented method of claim 1, wherein determining the data characterizing an image includes determining a degree of significance of said image.

6. The computer-implemented method of claim 1, wherein automatically processing the visual aspects of the image includes at least one of: identifying one or more individuals in the image, identifying the emotions of one or more individuals, identifying behaviors of one or more individuals, identifying objects in the image, identifying the location in the image, identifying the photographic quality of the image.

7. The computer-implemented method of claim 1, wherein generating a graphical representation of the images related to an event further includes accepting user input for modification of one or more presentation units of the graphical representation.

8. The computer-implemented method of claim 7, wherein accepting user input for modification of one or more presentation units of the graphical representation includes at least one of: modifying the layout of a subset of images; replacing images; adding images; removing images; resizing images; cropping images; reshaping images; adding textual annotations; modifying textual annotations; removing textual annotations; moving textual annotations; resizing textual annotations.

9. The computer-implemented method of claim 1, wherein generating a graphical representation of the images related to an event further includes automatically placing textual annotations based on the automatic processing of the visual aspects of the images.

10. The computer-implemented method of claim 1, wherein selecting the set of images to be presented in the graphical representation includes:
determining the number of images in the selected set based on user input; and
selecting the determined number of images according to the degree of significance of the images.

11. The computer-implemented method of claim 1, wherein partitioning the selected set of images into subsets of images includes:
for each subunit of the graphical representation, determining a layout of the corresponding subset of images.

12. The computer-implement method of claim 11, wherein the layout of the subset of images includes row or column positions of the images.

13. The computer-implemented method of claim 1, wherein determining visual characteristics includes:
associating an image with at least one textual description of the scene represented by the image.

14. The computer-implemented method of claim 1, wherein determining visual characteristics includes:
associating an image with at least one onomatopoeia based on the scene represented by the image.

15. The computer-implemented method of claim 1, wherein the visual characteristics of an image includes a size of the image.

16. The computer-implemented method of claim 1, wherein the visual characteristics of an image includes a shape of the image.

17. The computer-implemented method of claim 1, wherein the generated graphical representation of the scene includes a comic book style pictorial representation.

18. The computer-implemented method of claim 17, wherein each presentation unit of the graphical representation includes a page.

19. A system comprising:
an input data module for obtaining, from a machine-readable data storage, data including a plurality of images representative of scenes related to an event; and
a processor for generating a graphical representation of the event based on the obtained data, the processor being configured for:
for each one of the plurality of images, automatically determining data characterizing the image by processing the image, at least part of the processing including automatically processing visual aspects of the image;
selecting, from the plurality of images, a set of images to be presented in the graphical representation based at least on the data characterizing the images;
partitioning the selected set of images into subsets of images each subset to be presented in a respective one of one or more successive presentation units of the graphical representation; and
for each subset of images to be presented in a corresponding presentation unit of the graphical representation, determining visual characteristics based at least on the determined scores associated with the images.

20. The system of claim 19, further comprising an interface for accepting user input associated with a selection of images.

21. The system of claim 20, wherein the user input includes a specified number of successive presentation units of the graphical representation.

22. The system of claim 20, wherein the interface is further configured for accepting user edits to one or more images.

23. The system of claim 19, wherein the generated graphical representation of the event includes pictorial representation.

24. The system of claim 19, wherein the system further includes an output module for forming a data representation of the graphical representation of the event.

25. The system of claim 24, wherein the data representation includes a multimedia representation.

26. The system of claim 25, wherein the multimedia representation includes one or more of a JPEG file, a PNG file, a GIF file, a PDF file, a MPEG file, and a FLASH file.
